(19) United States
(12) Patent Application Publication
(10) Pub. No.: US 2026/0243281 A1
(43) Pub. Date: Aug. 20, 2026

(54) LEAKAGE CAUSE DISCRIMINATION SYSTEM AND LEAKAGE CAUSE DISCRIMINATION METHOD

(71) Applicant: KYB Corporation, Tokyo (JP)

(72) Inventor: Yusuke TAKAHASHI, Gifu (JP)

(73) Assignee: KYB Corporation, Tokyo (JP)

(21) Appl. No.: 19/160,945

(22) PCT Filed: Feb. 15, 2024
(86) PCT No.: PCT/JP2024/005185

§ 371 Date: Aug. 29, 2025

(30) Foreign Application Priority Data
Mar. 2, 2023 (JP) 2023-031749

(51) Int. Cl. F15B 19/00; F15B 15/14; F15B 20/00; G01M 3/26

(52) U.S. Cl. CPC F15B 19/005; F15B 15/1457; F15B 20/005; G01M 3/26; F15B 2211/87

(57) ABSTRACT

A leakage-cause discrimination system discriminates a cause of leakage of working fluid through an annular gap between a piston rod of a fluid pressure cylinder and a cylinder head through which the piston rod is inserted. The leakage-cause discrimination system includes a measurement unit provided on the fluid pressure cylinder, the measurement unit being configured to measure a state quantity of the working fluid leaking through the annular gap and a controller configured to acquire a measurement result from the measurement Unit. The controller discriminates the cause of leakage based on a change in the state quantity of the working fluid measured by the measurement unit.

### TECHNICAL FIELD

The present invention relates to a leakage-cause discrimination system and a leakage-cause discrimination method.

### BACKGROUND ART

JP2021-55708A discloses a construction machine that notifies that the replacement timing of sealing parts has been reached when it is determined that the cumulative amount of movement caused by extension and contraction of a hydraulic cylinder is equal to or greater than a threshold value. JP2021-173358A discloses a fluid pressure equipment monitoring system that determines, on the basis of a signal obtained from a fluid pressure sensor, whether the equipment is in a state of normal operation, maintenance, or use suspension.

### SUMMARY OF INVENTION

In fluid pressure cylinders, leakage of working fluid may occur through a gap between a piston rod and a cylinder head. Such leakage of the working fluid may occur not only when a seal reaches its normal product life, but also due to various other causes. However, in the determination of the replacement timing of the seal and in the determination of whether or not the leakage of the working fluid has occurred, it may not be possible to discriminate the cause of the leakage, and as a result, there is a risk in that a sufficient contribution cannot be achieved to the repairs, countermeasures, and management of a machine body of a construction machine, etc. having a liquid pressure cylinder.

The present invention has been made in view of such issue, and an object thereof is to discriminates the cause of leakage.

According to one aspect of the present invention, a leakage-cause discrimination system for discriminating a cause of leakage of working fluid through a gap between a piston rod of a fluid pressure cylinder and a cylinder head through which the piston rod is inserted, the leakage-cause discrimination system includes: measurement unit provided on the fluid pressure cylinder, the measurement unit being configured to measure a state quantity of the working fluid leaking through the gap; and a controller configured to acquire a measurement result from the measurement unit, wherein the controller discriminates the cause of leakage based on a change in the state quantity of the working fluid measured by the measurement unit.

### BRIEF DESCRIPTION OF DRAWINGS

FIG. 1 is a schematic view showing a configuration of a leakage-cause discrimination System according to an embodiment of the present invention.

FIG. 2 is a partial cross-sectional view of a fluid pressure cylinder according to the embodiment of the present invention.

FIG. 3 is an enlarged cross-sectional view of the fluid pressure cylinder according to the embodiment of the present invention.

FIG. 4 is a block diagram showing a part of functions of a controller according to the embodiment of the present invention.

FIG. 5 is a diagram showing examples of changes in pressure data according to causes of oil leakage.

FIG. 6 is an explanatory diagram of a plurality of determination regions.

FIG. 7 is an explanatory diagram of a first leakage-cause discrimination method.

FIG. 8 is an explanatory diagram of a second leakage-cause discrimination method.

### DESCRIPTION OF EMBODIMENTS

An embodiment of the present invention will be described below with reference to the attached drawings.

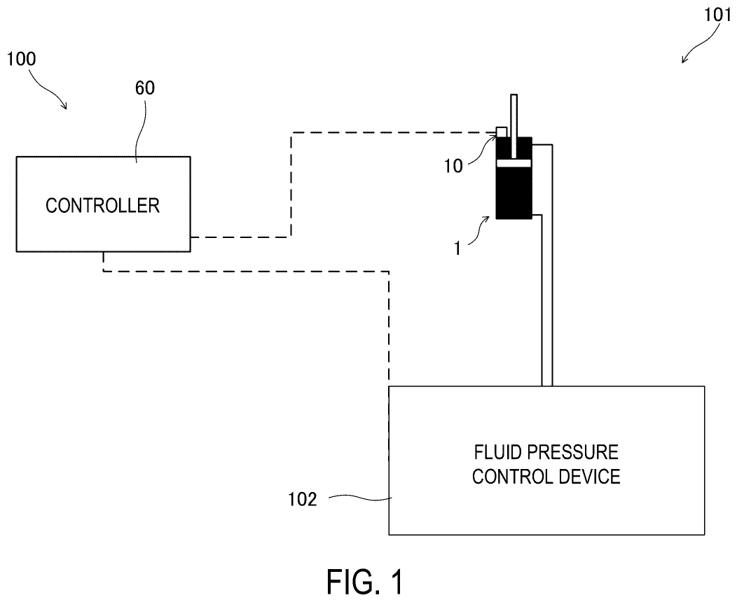

With reference to FIG. 1, an overall configuration of a fluid pressure system 101 including a leakage-cause discrimination system 100 will be described first.

The fluid pressure system 101 is used in a construction machine, in particular a hydraulic excavator, as a fluid pressure driven machine. In the fluid pressure system 101, flows of working fluid supplied to/discharged from a plurality of fluid pressure cylinders are controlled to drive the fluid pressure cylinders.

As shown in FIG. 1, the fluid pressure system 101 includes: a hydraulic cylinder 1 serving as the fluid pressure cylinder for driving objects to be driven (not shown), such as a boom, an arm, and a bucket; a fluid pressure control device 102 that controls operation of the hydraulic cylinder 1 by controlling supply/discharge of working oil (the working fluid) to/from the hydraulic cylinder 1; and the leakage-cause discrimination system 100.

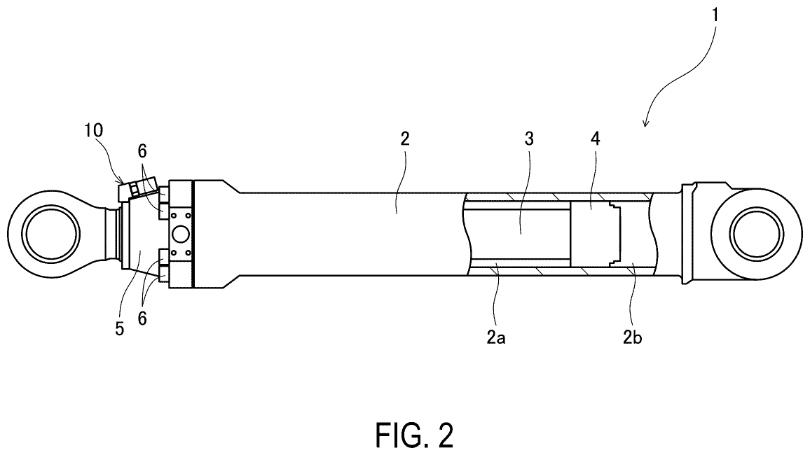

As shown in FIG. 2, the hydraulic cylinder 1 includes a cylindrical cylinder tube 2, a piston rod 3 that is inserted into the cylinder tube 2, and a piston 4 that is provided on a base end of the piston rod 3. The piston 4 is provided so as to be slidable along an inner circumferential surface of the cylinder tube 2. An interior of the cylinder tube 2 is partitioned by the piston 4 into a rod-side chamber (a fluid pressure chamber) 2a and an anti-rod-side chamber 2b.

The piston rod 3 extends out from the cylinder tube 2. A tip end of the piston rod 3 extends out from an opening end of the cylinder tube 2. As the working oil is selectively guided from a hydraulic pump (a hydraulic pressure source) (not shown) to the rod-side chamber 2a or the anti-rod-side chamber 2b, the piston rod 3 is moved relative to the cylinder tube 2. As a result, the hydraulic cylinder 1 is extended/contracted.

A cylinder head 5 through which the piston rod 3 is inserted is provided on the cylinder tube 2. The cylinder head 5 is provided on the opening end of the cylinder tube 2 and is fastened to the opening end of the cylinder tube 2 by using a plurality of bolts 6.

Because a known configuration can be employed for the fluid pressure control device 102, detailed illustration and explanation thereof will be omitted. The fluid pressure control device 102 controls the flow of the working oil guided to the hydraulic cylinder 1 from the hydraulic pump, thereby driving the hydraulic cylinder 1.

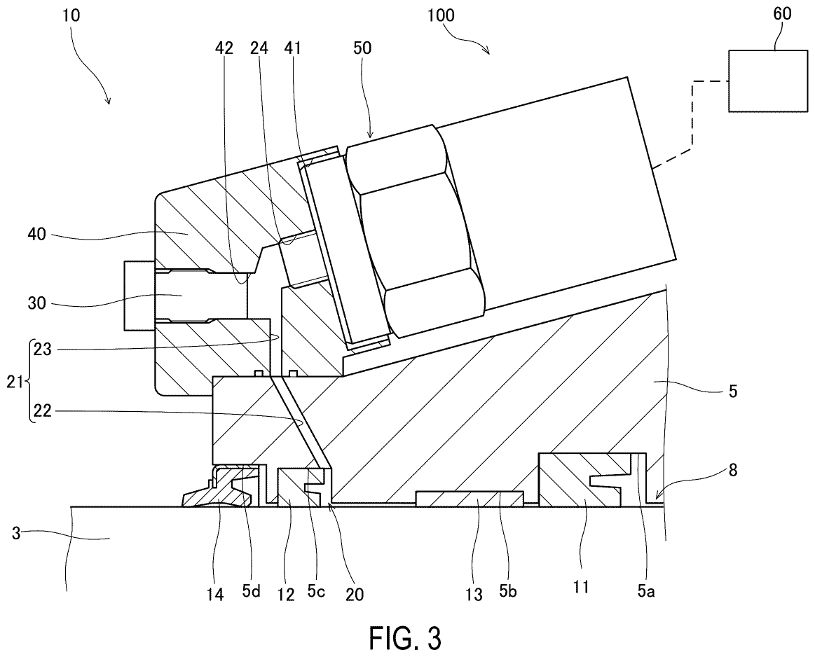

The leakage-cause discrimination system 100 detects occurrence of oil leakage of the working oil through a rod seal 11 (see FIG. 3) serving as a seal member provided in the hydraulic cylinder 1 and, in addition, discriminates the cause of the oil leakage. The leakage-cause discrimination system 100 detects the occurrence of the oil leakage in which the working oil leaks out from the rod-side chamber 2a through a gap between an outer circumferential surface of the piston rod 3 and an inner circumferential surface of the cylinder head 5. The leakage-cause discrimination system 100 may includes a plurality of hydraulic cylinders 1, and in this case, the leakage-cause discrimination system 100 can detect the occurrence of the oil leakage in each of the hydraulic cylinders 1.

As shown in FIGS. 1 and 3, the leakage-cause discrimination system 100 includes: a measurement unit 10 that is provided on the hydraulic cylinder 1 and measures the state quantity of the working oil leaking out through an annular gap (hereinafter referred to as “an annular gap 8”) between the outer circumferential surface of the piston rod 3 and the inner circumferential surface of the cylinder head 5; and a controller 60 that determines the occurrence of the oil leakage in the hydraulic cylinder 1 on the basis of the measurement result from the measurement unit 10.

As shown in FIG. 3, the measurement unit 10 includes: the rod seal 11 that is provided in the cylinder head 5 and seals the annular gap 8 between the outer circumferential surface of the piston rod 3 and the inner circumferential surface of the cylinder head 5; a detection space 20 into which the working oil, which has leaked out from the rod-side chamber 2a beyond the rod seal 11, is guided; a detection seal 12 that is provided in the cylinder head 5 and seals the annular gap 8, thereby partitioning the detection space 20 together with the rod seal 11; a communicating passage 21 that communicates with the detection space 20; a relief valve 30 that releases the pressure in the communicating passage 21 by being opened when the pressure in the communicating passage 21 reaches the relief pressure; a measurement part 50 that measures the state quantity of the working oil that has leaked out into the detection space 20 beyond the rod seal 11; and a housing 40 that accommodates the relief valve 30 and the measurement part 50.

In an inner circumference of the cylinder head 5, the rod seal 11, a bush 13, the detection seal 12, and a dust seal 14 are interposed in this order from the base end side (the right side in FIG. 3) to the tip end side (the left side in FIG. 3). The rod seal 11, the bush 13, the detection seal 12, and the dust seal 14 are respectively received in annular grooves 5a, 5b, 5c, and 5d each formed in the inner circumference of the cylinder head 5.

The bush 13 is provided so as to slide on the outer circumferential surface of the piston rod 3, and thereby, the piston rod 3 is supported so as be movable in the axial direction of the cylinder tube 2.

The rod seal 11 is compressed between an outer circumference of the piston rod 3 and the annular groove 5a in the inner circumference of the cylinder head 5, and thereby, the annular gap 8 is sealed. The rod seal 11 faces the rod-side chamber 2a (see FIG. 2), and the leakage of the working oil in the rod-side chamber 2a to the outside is prevented by the rod seal 11. The rod seal 11 is a so-called U-packing.

The dust seal 14 is provided in the cylinder head 5 so as to face the outside of the cylinder tube 2, and seals the annular gap 8. The dust seal 14 scrapes out dusts adhering to the outer circumferential surface of the piston rod 3, and prevents invasion of the dusts into the cylinder tube 2 from the outside.

Similarly to the rod seal 11, the detection seal 12 is compressed between the outer circumference of the piston rod 3 and the annular groove 5c in the inner circumference of the cylinder head 5, and thereby, the annular gap 8 is sealed. The detection seal 12 is provided between the rod seal 11 and the dust seal 14, and partitions the detection space 20 together with the rod seal 11. In other words, the detection space 20 is a space partitioned by the piston rod 3, the cylinder head 5, the rod seal 11, and the detection seal 12. Similarly to the rod seal 11, the detection seal 12 is a U-packing.

The communicating passage 21 is formed so as to extend from the cylinder head 5 and the housing 40 so as communicate with the detection space 20. The communicating passage 21 has a first communicating passage 22 that is formed in the cylinder head 5 so as to open to the detection space 20 and a second communicating passage 23 that is formed in the housing 40 so as to communicate with the first communicating passage 22. The working oil that has leaked out from the rod-side chamber 2a through the rod seal 11 is guided to the communicating passage 21 via the annular gap 8 and the detection space 20.

The relief valve 30 is opened when the pressure of the working oil in the second communicating passage 23 reaches a predetermined pressure (i.e. the relief pressure), and the working oil in the detection space 20 is discharged through the second communicating passage 23 to the outside. With such a configuration, the pressure in the detection space 20 is limited to the relief pressure by the relief valve 30. Because it is possible to employ a known structure for the structure of the relief valve 30, detailed illustration and description thereof are omitted.

The housing 40 is fixed to an end part of the cylinder head 5. The housing 40 is further formed with a sensor receiving hole 41 that receives the measurement part 50 and a valve receiving hole 42 that receives the relief valve 30. The sensor receiving hole 41 and the valve receiving hole 42 respectively communicate with the second communicating passage 23, and the valve receiving hole 42 communicates with the second communicating passage 23 at the first communicating passage 22 side (the upstream side) of the sensor receiving hole 41.

The measurement part 50 executes measurement of the pressure as the state quantity of the working oil and output of the measurement result to the controller 60 under a predetermined operating condition. In other words, the measurement part 50 executes the measurement of the pressure and the output of the measurement result at a predetermined operating frequency on the basis of a predetermined operating condition. The operating frequency includes a measurement frequency at which the measurement part 50 measures the pressure and a transmitting frequency at which the measurement result is transmitted from the measurement part 50 to the controller 60. In addition, the measurement part 50 is configured so as to be capable of measuring the temperature in the detection space 20.

The measurement part 50 measures the pressure in the detection space 20 at predetermined time intervals. As described above, the measurement part 50 does not detect the pressure in the detection space 20 constantly (continuously), but detects the pressure at predetermined detection intervals (intermittently), and so, it is possible to reduce power consumption.

The operation of the measurement part 50 can be controlled by the controller 60, and the measurement part 50 executes the pressure measurement and the output of the measurement result at the operating frequency of, for example, once per hour. When the detection (measurement) of the pressure is completed, the measurement part 50 wirelessly transmits the detection result to the controller 60.

The measurement part 50 may measure the temperature of the working oil as the state quantity of the working oil. In addition, as long as the measurement part 50 is capable of detecting the oil leakage in the detection space 20, the measurement part 50 may measure state quantities other than the pressure and the temperature.

The controller 60 is configured of a microcomputer including a CPU (central processing unit), a ROM (read only memory), a RAM (random access memory), and an I/O interface (input/output interface). The RAM stores data from processing executed by the CPU, the ROM pre-stores a control program, etc. for the CPU, and the I/O interface is used for input/output of information to/from a connected device. The controller 60 may be configured of a plurality of microcomputers. The controller 60 is programmed so as to be at least capable of executing the processing necessary for executing the control according to the present embodiment and a modification. The controller 60 may be configured as a single device, or may be divided into a plurality of devices and configured such that controls according to the present embodiment are respectively executed by the plurality of devices in a distributed processing.

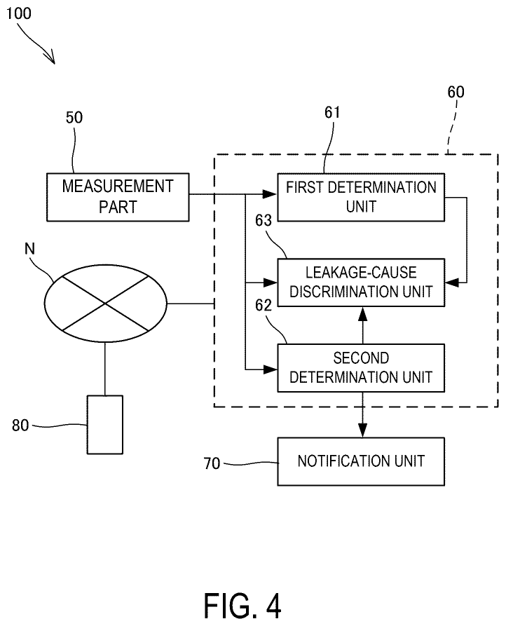

As shown in FIG. 4, the controller 60 includes: a first determination unit 61 that determines, on the basis of a detected value (a measured value) detected (measured) by the measurement part 50, the presence or absence of the leakage of the working oil in the hydraulic cylinder 1; a second determination unit 62 that determines whether or not the replacement timing of the rod seal 11 (hereinafter, simply referred to as a seal replacement timing) has been reached; and a leakage-cause discrimination unit 63 that discriminates the cause of the leakage of the working oil in the hydraulic cylinder 1. The first determination unit 61 and the like are illustrated as virtual units of respective functions of the controller 60, and do not mean that they physically exit. In addition, the above-described functions are part of the control executed by the controller 60, and the controller 60 also executes control related to functions other than these as appropriate.

The first determination unit 61, the second determination unit 62, and the leakage-cause discrimination unit 63 acquire a determination value used for determination from the detected value from the measurement part 50. The determination value is, for example, the detected value from the measurement part 50. The determination value may also be a calculated value obtained by performing a calculation with the detected value. The determination value may be common among the first determination unit 61, the second determination unit 62. and the leakage-cause discrimination unit 63, or may be different. The measurement is not limited to performing the detection once every predetermined time interval, and for example, the detection may be performed at predetermined sampling cycles during a predetermined detection period every predetermined time interval. In this case, for example, the maximum value or the average value of a plurality of detected values obtained at the predetermined sampling cycles within a predetermined detection period can be acquired as the determination value.

The first determination unit 61 determines the presence or absence of the oil leakage, and therefore whether or not the oil leakage has occurred, by determining whether or not the determination value is equal to or greater than a first determination threshold value Pc1 serving as the determination reference. Whether or not the oil leakage has occurred can be rephrased as whether or not deterioration (wear or damage) of the rod seal 11 has exceeded an allowable range, and if the determination value is lower than the first determination threshold value Pc1, and the deterioration of the rod seal 11 falls within the allowable range, it is determined that the oil leakage has not occurred. The determination result is input from the first determination unit 61 to the leakage-cause discrimination unit 63.

The second determination unit 62 determines whether or not the seal replacement timing has been reached by determining whether or not the determination value is equal to or greater than a second determination threshold value Pc2 serving as the determination reference. The determination result is input from the second determination unit 62 to a notification unit 70. The notification unit 70 notifies the determination result by the second determination unit 62 regarding the seal replacement timing in a recognizable form. The notification unit 70 is, for example, a warning lamp or an alarm device that emits a warning sound. By notification by the notification unit 70, an operator is notified that the seal replacement timing has been reached. The determination result from the second determination unit 62 is also input to the leakage-cause discrimination unit 63.

The leakage-cause discrimination unit 63 stores the determination value acquired on the basis of the detected value from the measurement part 50. Each time the determination value is acquired, the determination value is stored. As a result, the determination values are accumulated as the pressure data in accordance with the pressure of the working oil and the time. The pressure data includes the detected value of the pressure that is detected by the measurement part 50 and the calculated value that is obtained by the calculation from the detected value, and the pressure data is a value corresponding to the pressure of the working oil that is measured by the measurement unit 10.

In the accumulated pressure data, changes in the pressure of the working oil detected by the measurement part 50, and therefore, changes in the pressure of the working oil measured by the measurement unit 10 are reflected. The manner in which these changes appear differs depending on the cause of the oil leakage, such as a case in which the cause is due to the normal product life, and other cases, for example.

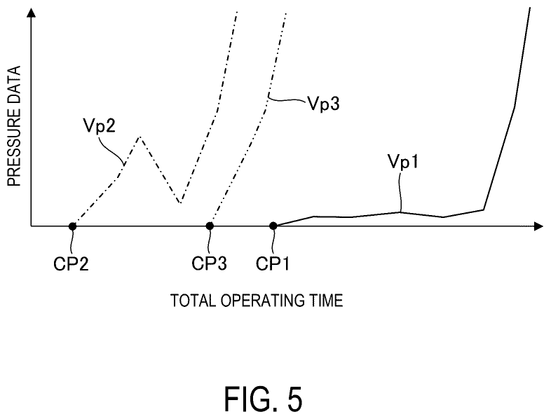

FIG. 5 is a diagram showing examples of changes in the pressure data according to the cause of the oil leakage. The vertical axis shows the pressure data, and the horizontal axis shows the total operating time of a construction machine to which the fluid pressure system 101 is applied (the machine body including the hydraulic cylinder 1). A change Vp1 indicates the change in the pressure data in a case in which the cause of the oil leakage is the normal product life. A change Vp2 indicates the change in the pressure data in a case in which the cause of the oil leakage is a severe environment, and a change Vp3 indicates the change in the pressure data in a case in which the cause of the oil leakage is a sudden event.

The case in which the cause is the normal product life corresponding to the change Vp1 is a case in which the rod seal 11 is deteriorated (worn) over time due to a steady load such as reciprocating motion of the piston rod 3. In this case, the oil leakage occurs at a time point CP1 when a reasonable period has elapsed from when the construction machine was first used. As can be seen from the change Vp1, in the case in which the cause is the normal product life, after the value of the pressure data begins to increase at the time point CP1, the value of the pressure data remains relatively low for a while, and thereafter, the value increases significantly.

The case in which the cause is the severe environment corresponding to the change Vp2 is a case in which the hydraulic cylinder 1 is used in an environment including a high level of contaminations (foreign matters), such as sands, etc., that promote the deterioration of the rod seal 11, so that a use environment is severe for the rod seal 11. Accordingly, in this example, the oil leakage occurs at a time point CP2 which is earlier than the time point CP1. In addition, as can be seen from the change Vp2, the value of the pressure data begins to increase from the time point CP2 with a steep slope. After the value of the pressure data begins to increase, the value of the pressure data increases again after undergoing pressure fluctuations as shown in the figure. These pressure fluctuations show a case in which, due to changes in a sealing performance caused by the temperature or sliding conditions, a level of the oil leakage is increased again after it is decreased temporarily.

The case in which the cause is the sudden event corresponding to the change Vp3 is a case in which the rod seal 11 is deteriorated (damaged) due to the sudden event such as collision of a stone or rock with the hydraulic cylinder 1. Therefore, in such a case, as can be seen from the change Vp3, the value of the pressure data begins to increase from a time point CP3, at which the sudden event occurred, with a slope steeper than that in the case in which the cause is the severe environment shown by the change Vp2.

As described above, the manner of the change in the pressure data differs among the case in which the cause is the normal product life, the case in which the cause is the severe environment, and the case in which the cause is the sudden event. Therefore, the leakage-cause discrimination unit 63 discriminates the cause of the oil leakage on the basis of the change in the accumulated pressure data, in other words, the change in the pressure of the working oil measured by the measurement unit 10. The leakage-cause discrimination unit 63 discriminates the cause of the oil leakage on the basis of the change in the pressure of the working oil after the time at which the oil leakage occurred.

For example, the leakage-cause discrimination unit 63 can calculate the slope of the change on the basis of the pressure data within a predetermined period after the time at which the oil leakage occurred and can discriminate the cause of the oil leakage on the basis of the calculated slope. For the slope, for example, the pressure data values are sequentially extracted in the acquisition order from a plurality of pressure data values acquired within a predetermined period, the slopes are sequentially calculated from each pair of pressure data values that are consecutive in the acquisition order, and an average value is obtained for a plurality of calculated slopes, thereby calculating the average value that can be employed as the slope.

In this case, if the calculated slope is less than a first slope determination value, it is possible to discriminate that the cause of the oil leakage is the normal product life. In addition, if the calculated slope is equal to or greater than the first slope determination value and less than a second slope determination value, it is possible to discriminate that the cause of the oil leakage is the severe environment, and if the calculated slope is equal to or greater than the second slope determination value and less than a third slope determination value, it is possible to discriminate that the cause of the oil leakage is the sudden event.

A predetermined period and each of the slope determination values can, for example, be set on the basis of the pressure data accumulated in advance by accumulating the pressure data values in advance for determining them, and they can also be reviewed on the basis of the pressure data accumulated thereafter. The slope is not limited to the above-described average value, and an appropriate calculated value that is calculated on the basis of the pressure data may be used.

By discriminating the cause of the oil leakage, it is possible to effectively utilize the discriminated cause of the oil leakage as information. As a result, it is possible to contribute to repair, countermeasure, and management of the machine body 41 construction machine, etc. having the hydraulic cylinder 1. As shown in FIG. 4, in this embodiment, an information terminal 80 such as a PC, etc. can be communicably connected to the controller 60 via a network N. Therefore, the cause of the oil leakage can be received as the information from the controller 60 by the information terminal 80 under the operation by a system operator, and can be confirmed via a display unit of the information terminal 80. The network N may be a wireless communication network or a wired communication network, and a cable, etc. may also be used instead of the network N. In addition, an information processing device other than the information terminal 80 may be used instead of the information terminal 80, and data may be input from the controller 60 to the information processing device via a storage medium. The same applies to the accumulated pressure data.

As can be seen from FIG. 5, the manner of the change in the pressure data differs depending on the cause of the oil leakage after the time point CP1, CP2, CP3, which is the time at which the oil leakage occurred, with reference to the time at which the oil leakage occurred.

Therefore, in this embodiment, the leakage-cause discrimination unit 63 discriminates the cause of the oil leakage on the basis of the change in the pressure data with reference to the time at which the oil leakage occurred (on the basis of the change in the pressure of the working oil measured by the measurement unit 10, specifically the change in the pressure of the working oil with reference to the time at which the oil leakage occurred). In other words, in this embodiment, by at least computationally aligning the times at which the oil leakage occurred, the timing of which differs depending on the cause of the oil leakage, the changes in the pressure data are made mutually comparable, and on the basis of which the cause of the oil leakage is discriminated. In order to grasp the change in the pressure data with reference to the time at which the oil leakage occurred, the determination result is input from the first determination unit 61 to the leakage-cause discrimination unit 63.

Upon discrimination of the cause of the oil leakage as described above, the leakage-cause discrimination unit 63 discriminates the cause of the oil leakage on the basis of a plurality of determination regions R, which will be described below.

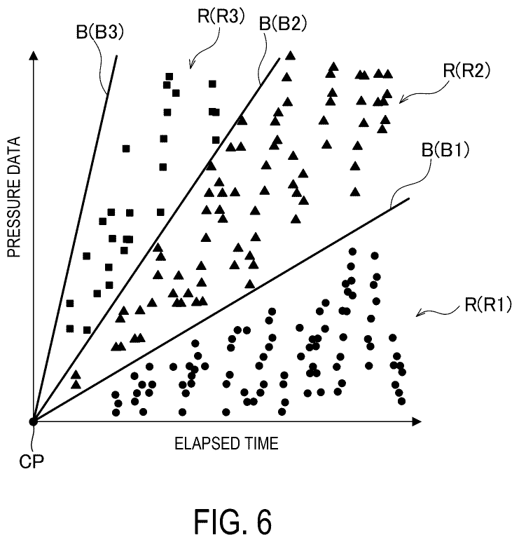

FIG. 6 is an explanatory diagram of the plurality of determination regions R. The vertical axis shows the pressure data, and the horizontal axis shows the elapsed time from the time at which the oil leakage occurred. The time point CP indicates the time at which the oil leakage occurred. The plurality of determination regions R are a plurality of determination regions according to the elapsed time from the time at which the oil leakage occurred and the pressure data, and are set for each cause of the oil leakage. The plurality of determination regions R can be preset, for example, in map data according to the elapsed time from the time at which the oil leakage occurred and the pressure data. The plurality of determination regions R may be set using a table, model equations that define the boundaries of the plurality of determination regions R, and so forth.

In this example, the plurality of determination regions R are set as follows. In other words, in this example, for each of the case in which the cause is the normal product life, the case in which the cause is the severe environment, and the case in which the cause is the sudden event, measurement points as shown in FIG. 6 have been obtained by accumulating the pressure data in advance. Circle marks indicate the measurement points for the case in which the cause is the normal product life, triangle marks indicate the measurement points for the case in which the cause is the severe environment, and square marks indicate the measurement points for the case in which the cause is the sudden event.

Therefore, in this example, on the basis of the measurement points that differ for each of the causes of the oil leakage, a plurality of boundary lines B for sorting these measurement points are set. A plurality of boundary lines B include a first boundary line B1, a second boundary line B2, and a third boundary line B3. The first boundary line B1 distinguishes between the case in which the cause is the normal product life and the case in which the cause is the severe environment. In addition, the second boundary line B2 distinguishes between the case in which the cause is the severe environment and the case in which the cause is the sudden event, and the third boundary line B3 distinguishes the case in which the cause is the sudden event together with the second boundary line B2. In this example, although each of the boundary lines B is a straight line, the boundary lines B are not limiter to straight lines, and the boundary lines B can be appropriately set on the basis of the different measurement points for each of the causes of the oil leakage.

The plurality of determination regions R are set by setting these boundary lines B1, B2, and B3 and include a first determination region R1, a second determination region R2, and a third determination region R3. The first determination region R1 is the determination region R on the side where the values of the pressure data are lower than the first boundary line B1 and corresponds to the case in which the cause is the normal product life. The second determination region R2 is the determination region R on the side where the values of the pressure data are larger than the first boundary line B1 and where the values of the pressure data are smaller than the second boundary line B2 and corresponds to the case in which the cause is the severe environment. The third determination region R3 is the determination region R on the side where the values of the pressure data are larger than the second boundary line B2 and where the values of the pressure data are smaller than the third boundary line B3 and corresponds to the case in which the cause is the sudden event. In this embodiment, although the number of the plurality of determination regions R is three, the plurality of determination regions R may be, for example, two determination regions R corresponding to the case in which the cause is the normal product life and another case.

In this case, it is possible to perform the discrimination on the basis of the plurality of determination regions R that are sorted according to the causes of the oil leakage by aligning the times at which the oil leakage occurred to the time point CP among the respective causes of the oil leakage, and so, the discrimination becomes easy. A specific discrimination method using the plurality of determination regions R is, for example, as follows.

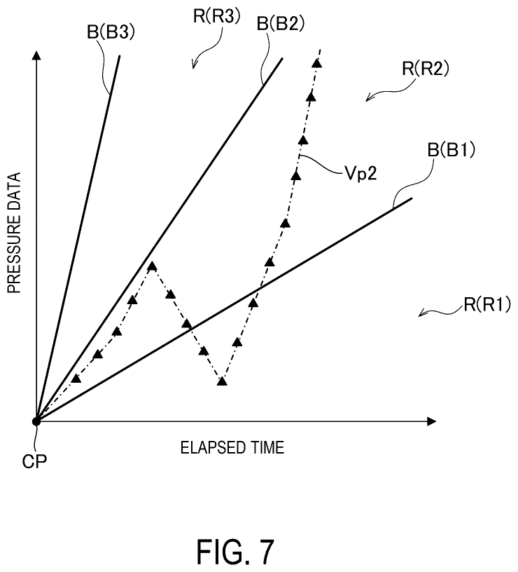

FIG. 7 is an explanatory diagram of a first leakage-cause discrimination method. In FIG. 7, the first leakage-cause discrimination method will be described using the above-described change Vp2 as an example. In FIG. 7, the above-described time points CP2 is aligned to the time point CP. In the first leakage-cause discrimination method, the leakage-cause discrimination unit 63 specifies the cause of the oil leakage by identifying, among the plurality of determination regions R, the determination region R that contains the greatest number of measurement points obtained on the basis of the measurement performed by the measurement unit 10 after the time at which the oil leakage occurred, that is, after the time point CP.

In the example shown in FIG. 7, the measurement points indicated by the triangle marks are most contained in the second determination region R2. Therefore, in this example, the leakage-cause discrimination unit 63 specifies that the cause of the oil leakage is the severe environment. In this manner, by specifying the cause of the oil leakage in accordance with the determination region R that contains the greatest number of measurement points, discrimination from the other cause can be achieved. In addition, in this case, because the discrimination method captures the change in the pressure data by means of a large number of measurement points, it is possible to perform highly accurate discrimination in accordance with the change in the pressure data.

The first leakage-cause discrimination method can specify the cause of the oil leakage when an execution condition for specifying the cause of the oil leakage is satisfied. The execution condition may be, for example, when a required time for specifying the cause of the oil leakage has elapsed from the time point CP, or when the value of the pressure data has reached a required value for specifying the cause of the oil leakage. The required time can be set to a time period appropriate for the plurality of determination regions R of a size suitable for the discrimination of the cause of the oil leakage. The same applies to the required value.

Such a first leakage-cause discrimination method is also suitable for collecting data for repairs and countermeasures through operation of the system. As a result, through such data collection, by grasping the tendency of the change in the pressure data according to the use condition and the use environment of the construction machine, to which the fluid pressure system 101 is applied, the contribution to the appropriate management of the machine body is also possible. In addition, because improvement of the discrimination accuracy by reviewing the boundary lines B also becomes possible, it also becomes possible to improve the discrimination accuracy through the operation of the system.

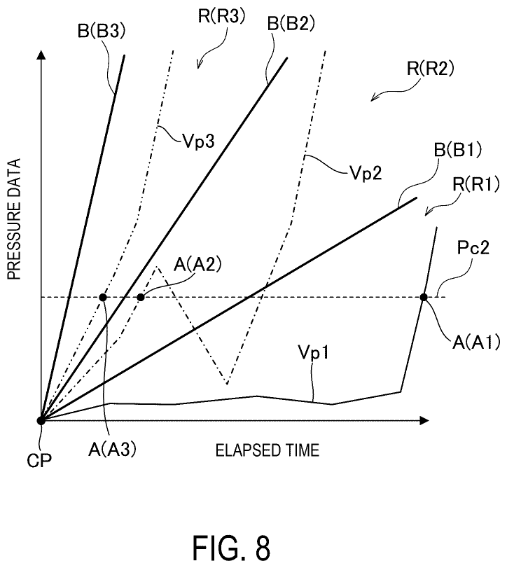

FIG. 8 is an explanatory diagram of a second leakage-cause discrimination method. In FIG. 8, the second leakage-cause discrimination method will be described using the above-described changes Vp1, Vp2, and Vp3 as examples. In FIG. 8, the above-described time points CP1, CP2, and CP3 are aligned to the time point CP. The second leakage-cause discrimination method specifies, among the plurality of determination regions R, the determination region R that includes the situation in which the second determination threshold value Pc2 is first reached as the value of the pressure data (the measurement data) obtained on the basis of the measurement performed by the measurement unit 10 after the time point CP first becomes equal to or greater than the second determination threshold value Pc2 for the seal replacement timing.

In order to grasp the measurement point at which the value of the pressure data first reached the second determination threshold value Pc2, the determination result is input to the leakage-cause discrimination unit 63 from the second determination unit 62. The leakage-cause discrimination unit 63 may determine by itself whether or not the value of the pressure data has reached the second determination threshold value Pc2 for the first time on the basis of the acquired pressure data. The second determination threshold value Pc2 corresponds to the threshold value. As the threshold value, for example, a threshold value other than the second determination threshold value Pc2 according to the degree of deterioration of the rod seal 11 may also be used.

The determination region R including the situation in which the second determination threshold value Pc2 has been first reached can be specified,, for example, by calculating the intersection point A between: (i) a straight line connecting the measurement point that has first become equal to or greater than the second determination threshold value Pc2 and the immediately preceding measurement point; and (ii) a straight line indicating the second determination threshold value Pc2, and by determining which determination region R the calculated intersection point A is included in. The cause of the oil leakage is then specified in accordance with the specified determination region R.

For example, the intersection point Al indicates the intersection point A for the change Vp1 and is included in the first determination region R1. Therefore, in this case, the cause of the oil leakage can be specified as the normal product life. Similarly, the intersection point A2 indicates the intersection point A for the change Vp2 and is included in the second determination region R2. Thus, in this case, the cause of the oil leakage can be specified as the severe environment. In addition, the intersection point A3 indicates the intersection point A for the change Vp3 and is included in the third determination region R3. Thus, in this case, the cause of the oil leakage can be specified as the sudden event.

According to the second leakage-cause discrimination method, it is possible to specify the cause of the oil leakage in accordance with the determination region R that includes the situation in which the pressure data has first become equal to or greater than the second determination threshold value Pc2, in other words, the intersection point A. As a result, it is possible to specify the cause of the oil leakage in accordance with the degree of deterioration of the rod seal 11 that has reached the seal replacement timing. Therefore, the system operator can realize the cause of the oil leakage in accordance with the degree of deterioration of the rod seal 11 that has reached the seal replacement timing, and can make use of the information of the cause of the oil leakage early for repairs, countermeasures, and a management of a machine body.

Even after the cause of the oil leakage has been discriminated by the second leakage-cause discrimination method, it is possible to continue the first leakage-cause discrimination method to perform the discrimination. In other words, these discrimination methods can be applied simultaneously. In this case, the cause of the oil leakage that has been discriminated can be stored separately as the information by the first leakage-cause discrimination method and the second leakage-cause discrimination method. Only one of the first leakage-cause discrimination method and the second leakage-cause discrimination method may be applied.

The leakage-cause discrimination unit 63 may discriminate the cause of the oil leakage on the basis of the pressure data obtained after a predetermined time set in advance has elapsed from the time at which the oil leakage occurred. This is because, for example, as shown in FIG. 6, in the initial state immediately after the occurrence of the oil leakage, the intervals between adjacent boundary lines B are narrow and each determination region R is narrow, and so, variations in the measurement points, or the like can affect the discrimination accuracy of the first leakage-cause discrimination method. In addition, by performing the discrimination on the basis of the pressure data obtained after a predetermined time has elapsed from the time at which the oil leakage occurred, the number of data points used in the discrimination is reduced regardless of which discrimination method is used, thereby contributing to a reduction in computational load.

Discrimination of the cause of the oil leakage in this manner can also be said to be with reference to the time at which the oil leakage occurred before a predetermined time has elapsed, and so, it is included in discrimination of the cause of the oil leakage on the basis of the change in the pressure data of the working oil with reference to the time at which the oil leakage occurred. The same applies to the elapsed time from the time point CP on the horizontal axis shown in FIGS. 6 to 8, and the elapsed time from the time point CP corresponds to the elapsed time with reference to the time at which the oil leakage occurred.

The configurations, operations, and effects of the embodiment of the present invention will be collectively described below.

The leakage-cause discrimination system 100 discriminates the cause of the oil leakage of the working oil through the annular gap 8 between the piston rod 3 of the hydraulic cylinder 1 and the cylinder head 5 through which the piston rod 3 is inserted. The leakage-cause discrimination system 100 includes: the measurement unit 10 provided on the hydraulic cylinder 1, the measurement unit 10 being configured to measure the pressure of the working oil leaking through the annular gap 8; and the controller 60 configured to acquire the measurement result from the measurement unit 10. The controller 60 discriminates the cause of the oil leakage on the basis of the change in the pressure data of the working oil, the change being the change in the pressure of the working oil measured by the measurement unit 10.

In the above, the pressure data of the working oil leaking through the annular gap 8 has different manner of change between, for example, the case in which the cause is the normal product life and the case with other causes. According to this configuration, because the cause of the oil leakage is discriminated on the basis of the change in the pressure data of the working oil, it is possible to discriminate the cause of the oil leakage. The same applies to leakage-cause discrimination method adapted for the leakage-cause discrimination system 100.

The controller 60 discriminates the cause of the oil leakage on the basis of the change in the pressure data of the working oil with reference to the time at which the oil leakage occurred.

When viewed with reference to the time at which the oil leakage occurred, the manner of the change in the pressure data as described above differs depending on the cause of the oil leakage. Thus, according to this configuration, because the cause of the oil leakage is discriminated on the basis of mutually comparable changes by focusing on such points, it is possible to appropriately discriminate the cause of the oil leakage.

The controller 60 discriminates the cause of the oil leakage on the basis of the plurality of determination regions R according to the elapsed time from the time point CP, in other words, the elapsed time with reference to the time at which the oil leakage occurred, and the pressure data of the working oil, the plurality of determination regions R being provided for each Cause of the oil leakage.

According to this configuration, because the times at which the oil leakage occurred are aligned to the time point CP among the causes of the oil leakage, and the discrimination is performed on the basis of the plurality of determination regions R divided according to the causes of the oil leakage, the discrimination is easily performed.

The controller 60 specifies the cause of the oil leakage by specifying, among the plurality of determination regions R, the determination region R that contains the greatest number of measurement points obtained on the basis of the measurement performed by the measurement unit 10 after the time at which the oil leakage occurred.

According to this configuration, by specifying the cause of the oil leakage by the cause of the oil leakage in accordance with the determination region R that contains the greatest number of measurement points, discrimination from the other cause can be achieved. In addition, in this case, because the discrimination method captures the change in the pressure data of the working oil by means of a large number of measurement points, it is possible to perform highly accurate discrimination in accordance with the change in the pressure of the working oil. Furthermore, in this case, by performing the data collection for repairs and countermeasures through the operation of the system, it becomes also possible to grasp the tendency of the change in the pressure data according to the use condition and the use environment of the construction machine, to which the fluid pressure system 101 is applied. As a result, the contribution to the appropriate management of the machine body is also achieved. In addition, because improvement of the discrimination accuracy by reviewing the boundary lines B also becomes possible, the improvement of the discrimination accuracy through the operation of the system also becomes possible.

The controller 60 specifies the cause of the oil leakage by specifying, among the plurality of determination regions R, the determination region R that includes the situation in which the value of the pressure data, which is obtained on the basis of the measurement unit 10 after the time point CP, has first become equal to or greater than the second determination threshold value Pc2.

According to this configuration, it is possible to specify the cause of the oil leakage in accordance with the determination region R that includes the situation in which the pressure data has first become equal to or greater than the second determination threshold value Pc2. As a result, it is possible to specify the cause of the oil leakage in accordance with the degree of deterioration of the rod seal 11 that has reached the seal replacement timing. Therefore, the system operator can realize the cause of the oil leakage in accordance with the degree of deterioration of the rod seal 11 that has reached the seal replacement timing, and can make use of the information of the cause of the oil leakage early for repairs, countermeasures, and a management of a machine body.

Embodiments of this invention were described above, but the above embodiments are merely examples of applications of this invention, and the technical scope of this invention is not limited to the specific constitutions of the above embodiments.

In the above-described embodiment, description has been given of a case in which the pressure data is a value corresponding to the total operating time (FIG. 5) and a case in which the pressure data is a value corresponding to the elapsed time from the time point CP, in other words, from the time at which the oil leakage occurred (FIGS. 6 to 8). However, for example, a total operating distance and a total number of operations of the hydraulic cylinder 1, the total number of data points in the pressure data may also be used instead of the total operating time, and in addition, for example, an operating distance or number of operations of the hydraulic cylinder 1, the number of data points in the pressure data since the time at which the oil leakage occurred may be used instead of the elapsed time from the time at which the oil leakage occurred.

In addition, in the above-described embodiment, although description has been given of a case in which the change in the state quantity of the working fluid is grasped by accumulating the pressure data (FIGS. 5 to 8), instead of the pressure data, a calculated value other than the calculated value included in the pressure data may also be used to grasp the change in the state quantity of the working fluid.

For other calculated values, values capable of indicating the degree of deterioration of the rod seal 11 including a degree of wear and a degree of damage may be used. As such other calculated values, for example, values obtained by multiplying the pressure data by other parameters (for example, temperature) or coefficients may be used. When other calculated values change according to the degree of deterioration of the rod seal 11, such a change simultaneously becomes one corresponding to the change in the state quantity of the working oil. Therefore, the use of such other calculated values is also included in the approach based on the change in the state quantity of the working fluid measured by the measurement unit.

The measurement part 50 may perform measurement regarding to the state of the working oil by measuring other measurement elements (measurement elements other than the state quantity of the working oil) that change according to the change in the state quantity of the working oil. For example, the measurement part 50 may measure an oil leakage amount leaking through the rod seal 11 or a sealing force of the rod seal 11, and on the basis of changes thereof, the measurement part 50 may grasp the change in the state quantity of the working oil. Such a case is also included in the approach based on the change in the state quantity of the working fluid measured by the measurement unit. Other measurement elements as described above may also be used instead of the pressure data on the vertical axis in FIGS. 5 to 8.

This application claims priority based on Japanese Patent Application No. 2023-031749 filed with the Japan Patent Office on Mar. 2, 2023, the entire contents of which are incorporated into this specification.

1. A leakage-cause discrimination system for discriminating a cause of leakage of working fluid through a gap between a piston rod of a fluid pressure cylinder and a cylinder head through which the piston rod is inserted, the leakage-cause discrimination system comprising:
a measurement unit provided on the fluid pressure cylinder, the measurement unit being configured to measure a state quantity of the working fluid leaking through the gap; and
a controller configured to acquire a measurement result from the measurement unit, wherein
the controller discriminates the cause of leakage based on a change in the state quantity of the working fluid measured by the measurement unit.

2. The leakage-cause discrimination system according to claim 1, wherein
the controller discriminates the cause of leakage based on a change in the state quantity of the working fluid measured by the measurement unit, the change being a change in the state quantity of the working fluid with reference to a time at which the leakage occurred.

3. The leakage-cause discrimination system according to claim 2, wherein
the controller discriminates the cause of leakage based on a plurality of determination regions according to an elapsed time with reference to the time at which the leakage occurred and the state quantity of the working fluid, the plurality of determination regions being provided for each cause of the leakage.

4. The leakage-cause discrimination system according to claim 3, wherein
the controller specifies the cause of leakage by specifying, among the plurality of determination regions, a determination region containing greatest number of measurement points obtained based on measurement performed by the measurement unit after the time at which the leakage occurred.

5. The leakage-cause discrimination system according to claim 3, wherein the controller specifies the cause of leakage by specifying, among the plurality of determination regions, a determination region including a situation in which a value of measurement data obtained based on measurement performed by the measurement unit after the time at which the leakage occurred first reached a threshold value.

6. The leakage-cause discrimination system according to claim 1, further comprising a rod seal configured to seal the gap formed with the cylinder head, wherein
the controller discriminates a plurality of the causes of leakage by discriminating the cause of leakage at the time at which the leakage occurred through the rod seal.

7. A leakage-cause discrimination method for discriminating a cause of leakage of working fluid through a gap between a piston rod of a fluid pressure cylinder and a cylinder head through which the piston rod is inserted, the leakage-cause discrimination method comprising:
a step of measuring a state quantity of the working fluid leaking through the gap, on the fluid pressure cylinder; and
a step of discriminating the cause of leakage based on a change in the state quantity of the working fluid measured.
